(19) United States
(12) Patent Application Publication
(10) Pub. No.: US 2006/0156344 A1
(43) Pub. Date: Jul. 13, 2006

(54) Network recording system and recording device

(76) Inventors: Yoshiaki Iwata, Moriguchi-shi (JP); Keiji Icho, Matsubara-shi (JP); Kentaro Tanikawa, Kadoma-shi (JP)

Correspondence Address: WENDEROTH, LIND & PONACK L.L.P., 2033 K. STREET, NW, SUITE 800, WASHINGTON, DC, 20006, US

(21) Appl. No.: 10/563,435

(22) PCT Filed: Jun. 7, 2004
(86) PCT No.: PCT/JP04/08255

§ 371 Date: Jan. 5, 2006

(30) Foreign Application Priority Data
Jul. 8, 2003 (JP) 2003-271928

(51) Int. Cl. H04N 7/173; G06F 3/00; G06F 13/00; H04N 5/445

(52) U.S. Cl. 725/58; 725/88; 725/89

(57) ABSTRACT

A device that performs a master/slave switching process dynamically changing a device functioning as a master device in a network in consideration of fixed device performances and also variable device states is provided. A device's own device information managing section (15) of a master device (1) manages device's own device information regarding its own device. Another device information managing section (16) manages other device information regarding other devices, which are slave devices. A schedule information managing section (17) manages schedule information regarding master device candidates. A device information processing section (13) obtains predetermined information, such as the remaining amount of battery, from a slave device specified based on the other device information and the schedule information at a predetermined time. The device information processing section (13) then compares the obtained predetermined information and the device's own device information to determine whether a device more suitable as the master device than its own device (1) is present. If such a suitable device is present, a master/slave switching process is performed with this suitable device.

### TECHNICAL FIELD

The present invention relates to a network system composed of a plurality of terminals and a recording server connected via a network. More particularly, the present invention relates to technology for allowing the shared use of recorded data stored in the recording server, among a plurality of users in a specific relationship.

### BACKGROUND ART

Recently, there are provided various types of video distribution services over a network such as the Internet, and a Local Area Network (LAN). One of such services is a broadcast program recording service.

In broadcast program recording services, a recording center receives from a user terminal (a mobile phone, for example) via a network, an instruction to record a broadcast program (hereinafter, referred to as a “record instruction”). In response, a recording server at the recording center records, in place of the user terminal, the broadcast program that is instructed to be recorded.

For the sake of copy right protection and privacy protection, it is general that a broadcast program recorded by the recording server is made available only to a specific user who instructed to record the broadcast program.

Yet, there is a demand for the shared used of recorded broadcast programs among users in a specific relationship, e.g. among family members or friends, so that each of the users is allowed to acquire any of the recorded broadcast programs irrespective of which member requested the recording.

### DISCLOSURE OF THE INVENTION

In view of the above demand, an object of the present invention is to provide a network recording system for allowing the shared use of recorded data among users having a specific relationship, and also to provide related techniques to the system.

To achieve the object stated above, the present invention is a network recording system including a plurality of terminals and a recording server connected via a network. Each terminal includes a transmitting unit operable to transmit to the recording server a record instruction to record a broadcast program and a send instruction to send a recorded broadcast program. Each instruction is transmitted together with a requester ID. The recording server includes: an ID management unit operable to manage specific requester IDs as belonging to a group; a recording unit operable to record a broadcast program in response to a record instruction transmitted from a terminal; a recorded-data management unit operable to manage a recorded broadcast program, in association with a requester ID that is transmitted with a record instruction instructed to record the broadcast program; and a shared-data management unit operable to send, in response to a send instruction, a recorded broadcast program to a terminal that transmitted the send instruction, when (i) a requester ID transmitted with the send instruction is managed by the ID management unit as belonging to a group and (ii) the recorded broadcast program to be sent is associated by the recorded-data management unit with a requester ID belonging to the group.

In another aspect, the present invention is a recording server that includes: a receiving unit operable to receive, from an external device, a record instruction to record a broadcast program and a send instruction to send a recorded broadcast program, each instruction being attached with a requester ID; an ID management unit operable to manage specific requester IDs as belonging to a group; a recording unit operable to record a broadcast program in response to a record instruction received by the receiving unit; a recorded-data management unit operable to manage a recorded broadcast program, in association with a requester ID that is received with a record instruction instructed to record the broadcast program; and a shared-data management unit operable to send, in response to a send instruction, a recorded broadcast program to an external device from which the send instruction is received, when (i) a requester ID received with the send instruction is managed by the ID management unit as belonging to a group and (ii) the recorded broadcast program to be sent is associated by the recorded-data management unit with a requester ID belonging to the group.

In yet another aspect, the present invention is a recorded data sending method for use by a recording server that has: a receiving unit operable to receive a record instruction to record a broadcast program and a send instruction to send a recorded broadcast program each transmitted from an external source together with a requester ID; and a recording unit operable to record a broadcast program in response to a received record instruction. The recorded data sending method includes steps of: managing specific requester IDs as belonging to a group; managing a broadcast program that is recorded in response to a record instruction received by the receiving unit, in association with a requester ID received with the record instruction; and sending, in response to a send instruction received from an eternal device, a recorded broadcast program to the external device from which the send instruction is received, when (i) a requester ID received with the send instruction is managed in the requester ID managing step as belonging to a group and (ii) the recorded broadcast program to be sent is associated in the broadcast program managing step with a requester ID belonging to the group.

In yet another aspect, the present invention is a program for use by a computer that performs a recorded data sending process. The computer acts as a recording server having: a receiving unit operable to receive a record instruction to record a broadcast program and a send instruction to send a recorded broadcast program each transmitted from an external source together with a requester ID; and a recording unit operable to record a broadcast program in response to a received record instruction. The recorded data sending process includes steps of: managing specific requester IDs as belonging to a group; managing a broadcast program recorded in response to a record instruction received by the receiving unit, in association with a requester ID received with the record instruction; and sending, in response to a send instruction received from an eternal device, a recorded broadcast program to the external device from which the send instruction is received, when (i) a requester ID received with the send instruction is managed in the requester ID managing step as belonging to a group and (ii) the recorded broadcast program to be sent is associated in the broadcast program managing step with a requester ID belonging to the group.

In yet another aspect, the present invention is a recording medium storing a program for use by a computer that performs a recorded data sending process. The computer acts as a recording server having: a receiving unit operable to receive a record instruction to record a broadcast program and a send instruction to send a recorded broadcast program each transmitted from an external source together with a requester ID; and a recording unit operable to record a broadcast program in response to a received record instruction. The recorded data sending process includes steps of: managing specific requester IDs as belonging to a group; managing a broadcast program recorded in response to a record instruction received by the receiving unit, in association with a requester ID received with the record instruction; and sending, in response to a send instruction received from an eternal device, a recorded broadcast program to the external device from which the send instruction is received, when (i) a requester ID received with the send instruction is managed in the requester ID managing step as belonging to a group and (ii) the recorded broadcast program to be sent is associated in the broadcast program managing step with a requester ID belonging to the group.

In yet another aspect, the present invention is an integrated circuit for use in a recording server that has: a receiving unit operable to receive a record instruction to record a broadcast program and a send instruction to send a recorded broadcast program each transmitted from an external source together with a requester ID; and a recording unit operable to record a broadcast program in response to a received record instruction. The integrated circuit includes: an ID management module operable to manage specific requester IDs as belonging to a group; a recorded-data management module operable to manage a recorded broadcast program that is recorded in response to a record instruction received by the receiving unit, the recorded broadcast being managed in association with a requester ID that is received with the record instruction; and a shared-data management module operable to send, in response to a send instruction, a recorded broadcast program to a terminal from which the send instruction is received, when (i) a requester ID received with the send instruction is managed by the ID management module as belonging to a group and (ii) the recorded broadcast program to be sent is associated by the recorded-data management module with a requester ID belonging to the group.

The requester ID used herein refers to information that uniquely identifies a user or a terminal owned by the user.

With the structures stated above, a user or a terminal owned by the user is allowed to acquire data that has been recorded by the recording server in response to a record request from another user, as long as requester IDs of the two users belong to the same group managed by the recording server. In other words, all users belonging to the same group are allowed the shared use of all data recorded in response to a record request issued by any user of the group.

Here, the shared-data management unit may generate, on a group-by-group basis, a shared-data list showing recorded broadcast programs that are associated with requester IDs belonging to a respective group out of all recorded broadcast programs managed by the recorded-data management unit, and transmit the shared-data list to each terminal. Each terminal may further include a generating unit operable to generate a send instruction based on the shared-data list.

With the structure stated above, each terminal is allowed to acquire recorded data that is listed in the shared-data list from the recording server.

Here, each terminal may further include: a presentation unit operable to present the shared-data list to a user; and a receiving unit operable to receive, from the user, a specification of a recorded broadcast programs selected from the shared-data list. The generating unit may generate a send instruction to send the recorded broadcast program that is selected by the user.

With the structure stated above, each terminal present a shared-data list from which a user can select a desired piece of recorded data.

Here, the receiving unit may receive designation of a group from a user. The transmitting unit may transmit, together with a requester ID, group information showing the designated group to the recording server. The ID management unit may manage group information transmitted from a terminal, in association with a requester ID that is transmitted with the group information.

With the structure stated above, a user is allowed to register a terminal as a member of a group to which the user belongs, by inputting information designating the group to the terminal.

Here, the receiving unit may receive, from a user, a record request requesting to record a broadcast program, and also receive notification setting as to whether to issue a notification about the record request to other users belonging to a same group to which the user belongs. The generating unit may generate a record instruction based on the received record request. The transmitting unit may transmit, in addition to the generated record instruction, the notification setting together with a requester ID to the recording server. The shared-data management unit may issue, in accordance with notification setting transmitted with a record instruction from a terminal, a notification about the record instruction to each terminal that transmitted a requester ID belonging to a same group to which the requester ID transmitted with the notification setting belongs.

With the structure stated above, when a user requests the recording server to record a broadcast program, a notification about the request is issued to the other users in the same group. On receiving the notification, the other users are saved unnecessary trouble of requesting a broadcast program that has been already requested to be recorded, thereby offering improved user convenience.

Here, the receiving unit may receive, from a user, a delete request requesting to delete a recorded broadcast program. The generating unit may generate a delete instruction based on the received delete request. The transmitting unit may transmit the generated delete instruction together with a requester ID to the recording server. The shared-data management unit may delete, in response to a delete instruction transmitted from a terminal, a recorded broadcast program from the recording server, when the recorded broadcast program to be deleted is associated with a requester ID belonging to a same group to which a requester ID transmitted with the delete instruction belongs.

With the structure stated above, recorded data that is shared among the users of a group may be deleted by any user belonging to that group.

Here, the shared-data management unit may delete from the recording server a recorded broadcast program that is listed in the shared-data list, when the recorded broadcast program is sent to all users or terminals identified by the requester IDs belonging to the group.

With the structure stated above, recorded data that is shared among the users of a group is automatically deleted when the recorded data is sent to all the terminals owned by the users of the group. This helps to control the volume of ever-increasing recorded data by deleting a piece that is no longer necessary.

Here, each time the recorded-data management unit newly associates a requester ID and a recorded broadcast program, the shared-data management unit may update the shared-data list and transmit a new shared-data list to each terminal.

With the structure stated above, the recording server transmits to each terminal a new shared-data list each time the shared-data list is updated. This ensures that each terminal always holds a shared-data list that is most up-to-date.

### BRIEF DESCRIPTION OF THE DRAWINGS

FIG. 1 is a view illustrating a structure of a network recording system according to the present invention;

FIG. 2 is a view illustrating the structure of the network recording system;

FIG. 3 is a view illustrating an example of a channel table;

FIG. 4 is a view illustrating an example of program guide information;

FIG. 5 is a view illustrating an example of a registration request screen;

FIG. 6 is a view illustrating a data structure of registration information that a terminal transmits to a recording server;

FIG. 7 is a view illustrating an example of a group list managed by the recording server;

FIG. 8 is a view illustrating an example of a record request screen;

FIG. 9 is a view illustrating a data structure of a record instruction that the terminal transmits to the recording sever;

FIG. 10 is a view illustrating an example of a recorded-data list managed by the recording server;

FIG. 11 is a view illustrating an example of a shared-data list managed by the recording server;

FIG. 12 is a view illustrating an example of a send request screen;

FIG. 13 is a flowchart illustrating operations for registration-request reception processing;

FIG. 14 is a flowchart illustrating operations for group registration processing;

FIG. 15 is a flowchart illustrating operations for record-request reception processing;

FIG. 16 is a flowchart illustrating operations for shared-data list send processing;

FIG. 17 is a flowchart illustrating operations for send-request reception processing;

FIG. 18 is a flowchart illustrating operations for shared-data send processing;

FIG. 19 is a view illustrating an example of a record request screen;

FIG. 20 is a view illustrating an example of a record request notification screen;

FIG. 21 is a view illustrating an example of a shared-data acquisition state table;

FIG. 22 is a view illustrating an example of a notification recommending a user to delete recorded data; and

FIG. 23 is a view illustrating an example of a notification notifying that recorded data is automatically deleted.

### BEST MODE FOR CARRYING OUT THE INVENTION

The following describes an embodiment of a network recording system according to the present invention, with reference to the accompanying drawings.

1. Structure of Network Recording System 1

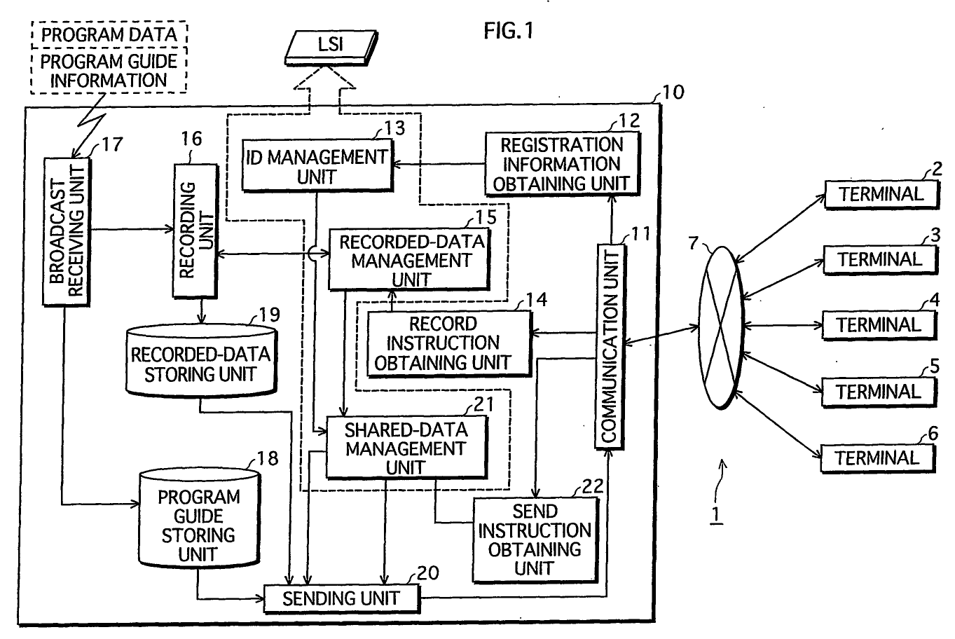

FIG. 1 illustrates a structure of a network recording system 1, along with function blocks of a recording server 10.

The network recording system 1 is composed of the recording server 10, terminals 2-6, and a network 7.

Note that although the figure illustrates five terminals, the number of terminals is not limited to five. The system may include thousands to tens of thousands of terminals. Similarly, the number of recording severs is not limited to one. The system may include thousands to tens of thousands of recording servers.

The network 7 is a LAN or the Internet.

Each of the recording server 10 and terminals 2-6 is a computer constituted of hardware, such as a CPU, input/output devices (a receiving tuner, a communications modem, and a UI (User Interface) circuit), a memory, and a hard disk.

1.1 Structure of Recording Server

Next, description is given to function blocks of the recording server 10.

The recording server 10 includes a communication unit 11, a registration information obtaining unit 12, an ID management unit 13, a record instruction obtaining unit 14, a recorded-data management unit 15, a recording unit 16, a broadcast receiving unit 17, a program guide storing unit 18, a recorded-data storing unit 19, a sending unit 20, a shared-data management unit 21, and a send instruction obtaining unit 22.

Functions of the recording server 10 are realized by the CPU executing a control program that is stored in the memory or hard disk of the recording server 10.

As illustrated in FIG. 1, the ID management unit 13, recorded-data management unit 15, and shared-data management unit 21 are implemented in an integrated circuit.

The communication unit 11 has a function of communicating with the other devices connected to the network 7 and constituted of hardware such as a LAN card or a modem.

The registration information obtaining unit 12 has a function of obtaining registration information transmitted from each terminal. The registration information is then passed to the ID management unit 113. The registration information includes a group ID, a group name (hereinafter, a pair of group ID and group name is referred to as “group information”), and a terminal ID, which is information uniquely identifying a terminal that transmitted the registration information. The registration information additionally includes information requesting registration of the terminal into a group or to withdrawal from a currently registered group.

The ID management unit 13 has a function of managing terminal IDs of the terminals on a group-by-group basis. Further, on receiving registration information from the registration information obtaining unit 12, the ID management unit 13 newly registers a terminal ID contained in the received registration information to a requested group if registration is requested. Alternatively, if withdrawal is requested, the ID management unit 13 deletes the contained terminal ID from a group to which the terminal ID currently belongs.

The record instruction obtaining unit 14 has a function of obtaining a record instruction and a terminal ID both transmitted from each terminal. The record instruction contains a program ID of a broadcast program requested by the user to be recorded. The record instruction and the terminal ID are then passed to the recorded-data management unit 15.

The recorded-data management unit 15 has a function of managing the program ID contained in a record instruction received from the record instruction obtaining unit 14, in association with a terminal ID identifying the terminal that transmitted the record instruction. The program ID is then passed to the recording unit 16.

The broadcast receiving unit 17 has a function of receiving digital broadcasts and demodulating received broadcast waves. The digital broadcasts refer to the broadcasts that use a Moving Picture Experts Group 2(MPEG2)-Transport Stream (TS) scheme compliant with ISO/IEC 13818.

Each TS packet that together constitutes a TS contains, in its header, identification information identifying the contents of payload. The broadcast receiving unit 17 extracts each data item from the TS packets with reference to the identification information. Data items to be extracted include program data composed mainly of video and audio data, and program guide information. The extracted program data is passed to the recording unit 23, and the extracted program guide information is passed to the program guide storing unit 18.

The recording unit 16 records a broadcast program identified by the program ID passed from the recorded-data management unit 15. The recording unit 16 may simply record a requested broadcast program in an original data format, or may perform recording involving conversion to a user requested data format. For example, an MPEG2 formatted broadcast program may be converted to an MPEG4 format. The recorded broadcast program, i.e. recorded data is then stored in the recorded data storing unit 19.

The recorded-data storing unit 19 is a storage area used for storing recorded data passed from the recording unit 16.

The program guide storing unit 18 is a storage area used for storing program guide information passed from the broadcast receiving unit 17.

Program guide information is composed of a plurality of tables called Program Specific Information (PSI) and Service Information (SI) each in compliance with an MPEG-2 system standard.

The send instruction obtaining unit 22 has a function of obtaining a send instruction and a terminal ID both transmitted from each terminal. The send instruction includes a program ID identifying recorded data that the user requests to acquire. The send instruction and terminal ID are then passed to the shared-data management unit 21.

The shared-data management unit 21 has a function of generating, on a group-by-group basis, a list of pieces of recorded data that are available to all terminals of a respective group (hereinafter, referred to as a “shared-data list”). To this end, the shared-data management unit 21 extracts from the recorded-data management unit 15, program IDs corresponding to broadcast programs already recorded. The shared-data management unit 21 then sorts the extracted program IDs based on the groups to which respective terminal IDs associated with the program IDs belong, and generates a separate shared-data list for each group. In addition, the shared-data management unit 21 has a function of instructing the sending unit 20 to send recorded data that is identified by the program ID contained in a send instruction received from the send instruction obtaining unit 22, to a terminal that issued the send instruction.

The thus generated shared-data lists are passed to the sending unit 20.

The sending unit 20 has a function of data transmission using, for example, the Hypertext Transfer Protocol (HTTP) or the File Transfer Protocol (FTP).

Data that the sending unit 20 may transmit includes recorded data stored in the recorded-data storage unit 19, program guide information stored in the program guide storing unit 18, and shared-data lists generated by the shared-data management unit 21. Recorded data is transmitted to an appropriate terminal in response to an instruction from the shared-data management unit 21.

1.2 Structure of Terminals

Next, description is given to function blocks of the terminals.

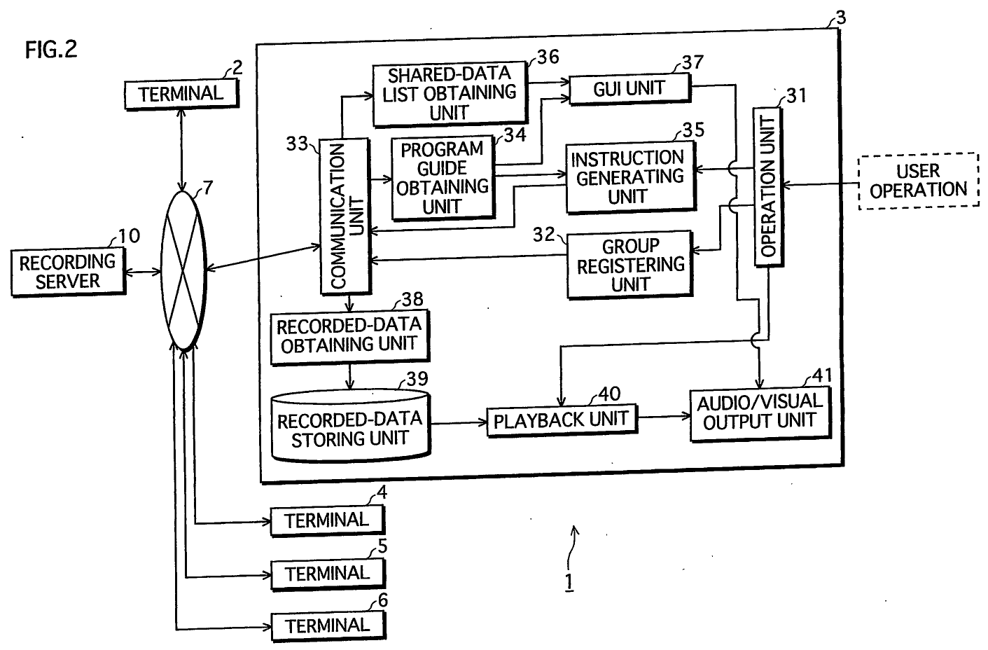

FIG. 2 illustrates the structure of the network recording system 1, along with function blocks of the terminal 3.

The terminal 3 includes an operation unit 31, a group registering unit 32, a communication unit 33, a program guide obtaining unit 34, an instruction generating unit 35, a shared-data list obtaining unit 36, a GUI unit 37, a recorded-data obtaining unit 38, a recorded-data storing unit 39, a playback unit 40, and an audio/visual output unit 41. Since the terminals 2, 4, 5, and 6 each have identical function blocks to those in the terminal 3, no description is given to the other terminals.

The terminal 3 is constituted of hardware, such as a CPU, a memory, and a hard disk. Functions of the terminal 3 are realized by the CPU executing a control program stored in the memory or hard disk.

The GUI unit 37 has a function of generating Graphical User Interface (GUI) data used for displaying, on a display monitor, GUI elements each associated with a specific attribute. The GUI elements include images of icon buttons, which are graphical representation of texts and/or pictures.

Generally, personal computers and various types of audio-visual devices receive user operations and present information to users through a GUI. The same description applies to the terminal 3.

GUI screens include: a record request screen for receiving record requests, generated based on program guide information passed from the program guide obtaining unit 34; a send request screen for receiving send requests, generated based on shared-data list passed from the shared-data list obtaining unit 36; and a registration request screen for receiving registration requests.

The operation unit 31 has a function of receiving various user requests that a user inputs using buttons displayed. To be more specific, for example, the operation unit 31 receives user requests that a user inputs, with a pointing device, to a GUI screen generated by the GUI unit 37.

The operation unit 31 passes received user requests to appropriate units. To be more specific, record requests and send requests are passed to the instruction generating unit 35, whereas registration requests are passed to the group registering unit 32. Further, playback requests requesting playback of recorded data that is stored in the recorded-data storing unit 39 is passed to the playback unit 40.

The group registering unit 32 has a function of generating registration information according to a registration request received from a user. The details of registration information will be given later.

The instruction generating unit 35 has a function of generating instructions to be transmitted to the recording server 10. A record instruction is generated according to a received record request, and a send instruction is generated according to a send request. The details of record instruction and send instruction will be described later.

The thus generated record instruction and send instruction are passed to the communication unit 33.

The communication unit 33 is constituted of hardware such as a LAN card or modem, and has a function of communicating with the other devices connected to the network 7. Upon each transmission of data, the communication unit 33 also transmits the terminal ID of the terminal 3.

The shared-data list obtaining unit 36 has a function of obtaining a shared-data list transmitted from the recording server 10.

The program guide obtaining unit 34 has a function of obtaining program guide information transmitted from the recording server 10. The program guide information is used as source information for generating a record request screen.

The recorded-data obtaining unit 38 has a function of obtaining recorded data sent from the recording server 10. The recorded-data obtaining unit 38 may receive recorded data by either of a downloading scheme and a streaming scheme. The thus obtained recorded data is then stored to the recorded-data storing unit 39.

The recorded-data storing unit 39 is a storage area used for storing recorded data that is obtained by the recorded-data obtaining unit 38.

The playback unit 40 has a function of reading recorded data from the recorded-data storing unit 39 to play back the read data.

The audio/visual output unit 41 has a function of outputting audio and visual data played back by the playback unit 40, and GUI screens generated by the GUI unit 37.

2. Details of Data

Next, description is given to various data items in detail.

2.1 Channel Table

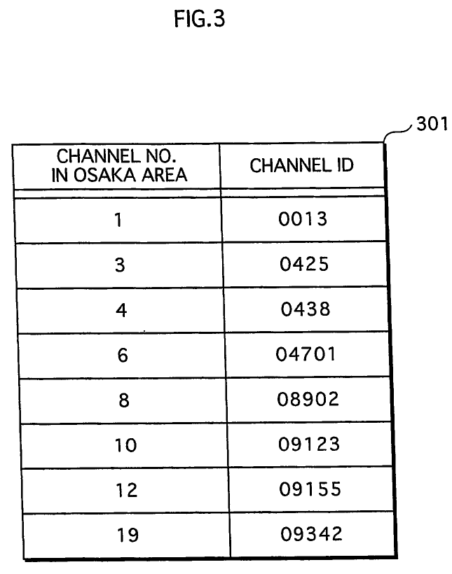

FIG. 3 illustrates one specific example of a channel table showing channels and their channel IDs determined for a specific broadcast area.

The channel table is stored in the memory of each terminal. The channel table 301 and the program guide information are used as source information by GUI unit 37 for generating a record request screen.

2.2 Program Guide Information

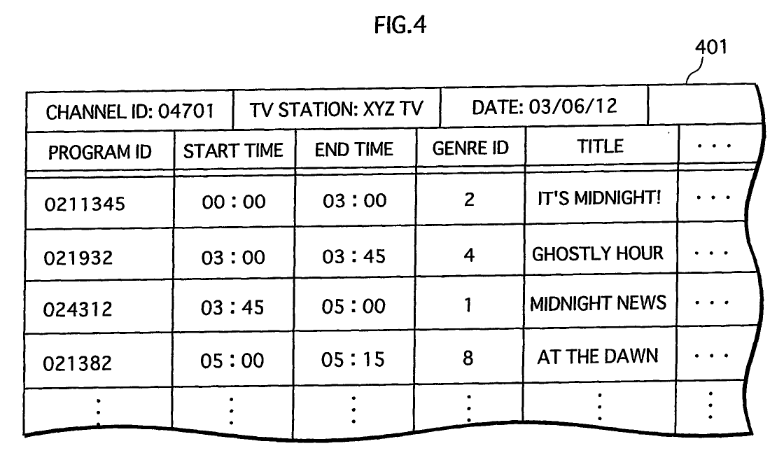

FIG. 4 illustrates one specific example of program guide information.

A program guide 401 is composed of information items, such as a channel ID, a television station, a broadcast date, a program ID, a program-start time, a program-end time, a genre ID, and a program title. The program guide information is used by the recording server 10 to identify the program title, program-start time, and program-end time corresponding to a program ID contained in a record request or send request received from each terminal. In each terminal, the program guide information is used as source information for generating a record request and send request.

2.3 Registration Information

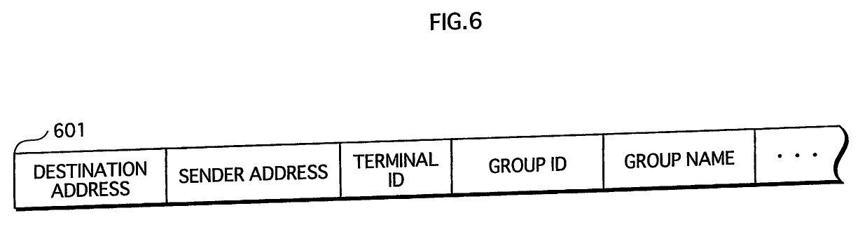

FIG. 6 illustrates a data structure of registration information that the terminal 3 transmits to the recording sever 10.

Registration information 601 is composed of information items, such as a destination address, a sender address, a terminal ID, a group ID, and a group name.

2.4 Group List

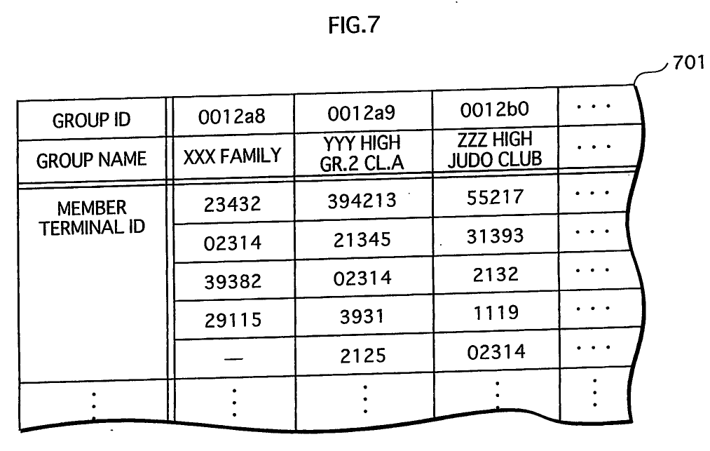

FIG. 7 illustrates a specific example of a group list showing terminal IDs managed by the ID management unit 13, on a group-by-group basis.

A group list 701 in the figure shows three groups. One of the groups has a group ID “0012a8” and group name “XXX family”, and four terminals having the terminal IDs “23432”, “02314”, “39382,” and “29115” belong to the “XXX family” group.

Although terminals are indicated by their terminal IDs in this example, any other information may be used to indicate the terminals. For example, terminals may be indicated by user IDs, user names, or nicknames of users operating the terminals.

2.5 Record Request

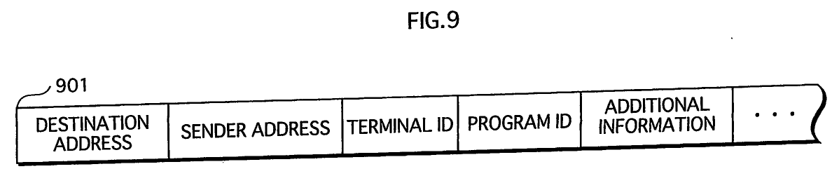

FIG. 9 illustrates a data structure of a record instruction that the terminal 3 transmits to the recording sever 10.

A record instruction 901 is composed of data items, such as a destination address, a sender address, a terminal ID, a program ID, and additional information.

2.6 Recorded-Data List

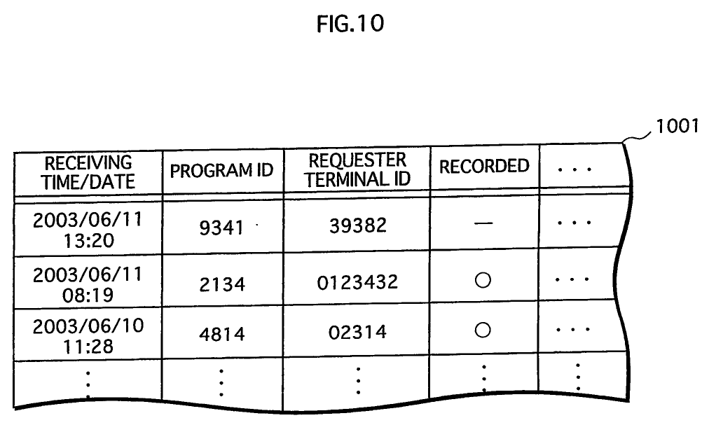

FIG. 10 illustrates a specific example of a recorded-data list showing recorded broadcast programs and related terminal IDs.

A recorded-data list 1001 illustrated in the figure is composed of columns of a receiving time/date at which a record request is received, a program ID of a requested program, a requester terminal ID of a terminal issued a corresponding record request, a recording checkbox in which a flag is to be set upon completion of recording.

2.7 Shared-Data List

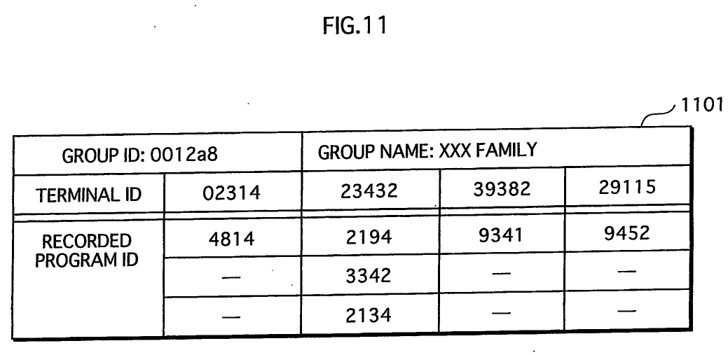

FIG. 11 illustrates a specific example of a shared-data list generated by the shared-data management unit 21 separately for each group.

A shared-data list 1101 is of the “XXX Family” group, and contains program IDs of already recorded program of which recording is requested by terminals belonging to the “XXX Family” group. The program IDs are listed separately for each terminal ID of the group.

3. Operations

Now, description is given to operations of the network recording system 1.

3.1 Registration-Request Reception Processing

First, description is given to registration-request reception processing performed by the terminal 4.

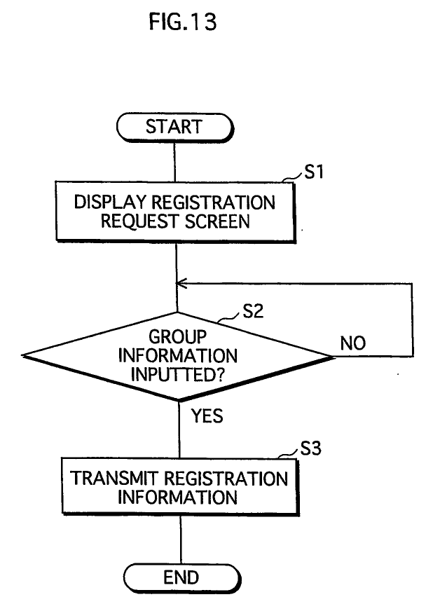

FIG. 13 is a flowchart illustrating operations performed by the terminal 4 for the registration-request reception processing.

On receiving a user input for initiating registration request entry, the terminal 4 displays a registration request screen (step S1).

At a click of a submit button by a user after entering group information into the displayed registration request screen (step S2: YES), the group registering unit 32 generates registration information, and the communication unit 33 transmits the registration information to the recording server 10 (step S3).

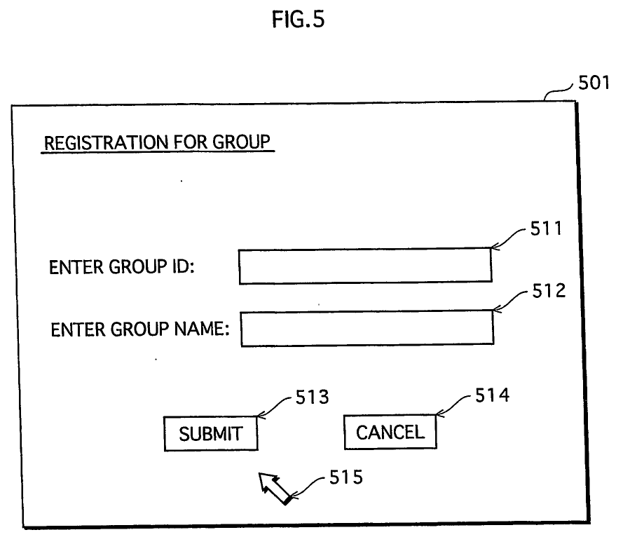

With reference to FIG. 5, specific description is given to the registration-request reception processing performed by the terminal 4.

FIG. 5 illustrates an example of the registration request screen used for receiving a user request for registration into a group.

A registration request screen 501 is generated by the GUI unit 37, and displayed on an external monitor via the audio/visual output unit 41.

The registration request screen 501 contains a group ID entry field 511, a group name entry field 512, a submit button 513, a cancel button 514, and a pointer 515.

By moving the pointer 515 using a pointing device such as a remote controller, a user selects an appropriate one of the group ID entry field 511, group name entry field 512, submit button 513, and cancel button 514 to enter text into the selected field or to click the selected button.

It is applicable to require either or both of the group ID and group name be inputted. Users may obtain the group information from the recording server 10 by issuing a query thereto, or by asking another user of the group in person.

At a click of the submit button 513 by the user after entering a group ID into the group ID entry field 511 and/or a group name into the group name entry field 512, the group registering unit 32 generates registration information. The thus generated registration information is then transmitted together with the terminal ID to the recording server 10 by the communication unit 33.

On the other hand, at a click of the cancel button 514, the information having been entered into the group ID entry field 511 and/or group name entry field 512 is all cleared.

3.2 Group Registration Processing

Next, description is given to processing performed by the recording server 10 for registering a terminal ID into a group.

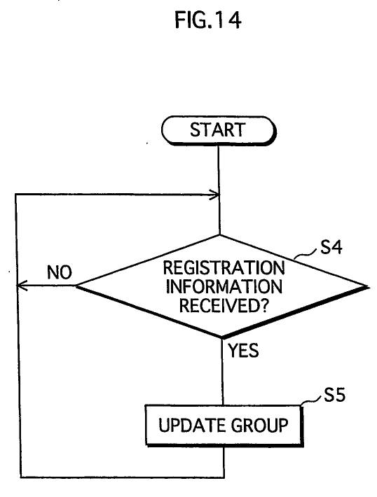

FIG. 14 is a flowchart illustrating operations performed by the recording server 10 for the group registration processing.

When the recording server 10 receives registration information from any of the terminals (step S4, YES), the ID management unit 13 manages the group information contained in the received registration information in association with the terminal ID, thereby updating information about a related group (step S5).

3.3 Record-Request Reception Processing

Next, description is given to record-request reception processing.

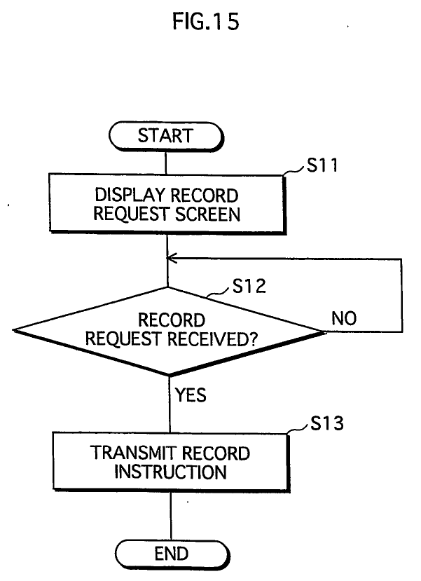

FIG. 15 is a flowchart illustrating operations performed by the terminal 4 for the record-request reception processing.

On receiving a user input for initiating a record request entry, the terminal 4 displays the record request screen on the external monitor (step S1).

On receiving a record request entered by the user into the thus displayed record request screen (step S12: YES), the instruction generating unit 35 generates a record instruction. The communication unit 33 then transmits the thus generated record instruction to the recording server 10 (step S13).

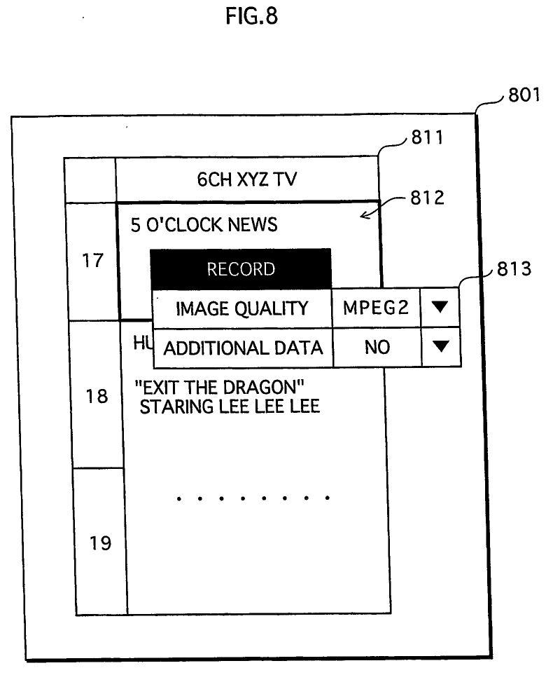

With reference to FIG. 8, specific description is given to the record-request reception processing performed by the terminal 4.

FIG. 8 illustrates an example of a record request screen used for receiving a user request to record a broadcast program.

A record request screen 801 is generated by the GUI unit 37, and displayed on the external monitor via the audio/visual output unit 41.

The record request screen 801 displays a program guide 811 that is generated based on the program guide information and the channel table. As shown in the figure, the program guide 811 presents the broadcast schedule of XYZ Television for Osaka Area 6, from 17:00-19:00. When a program listing column 812 is selected with the pointer, a recording detail window 813 appears.

In the recording detail window 813 appears three GUI elements, which are a “RECORD” button, an “IMAGE QUALITY” button, and an “ADDITIONAL DATA” button. At a click of the “IMAGE QUALITY” button, a plurality buttons corresponding to various image qualities appear, so that a user is allowed to select a desired image quality at a click of an appropriate button.

Further, at a click of the “ADDITIONAL DATA” button, “YES” button and “NO” button appear, so that a user is allowed to select whether to add any data to a broadcast program to be recorded.

At a click of the “RECORD” button, a user can input to the terminal 3, a request to record a broadcast program.

3.4 Shared-Data List Send Processing

Next, description is given to shared-data list send processing performed by the recording server 10.

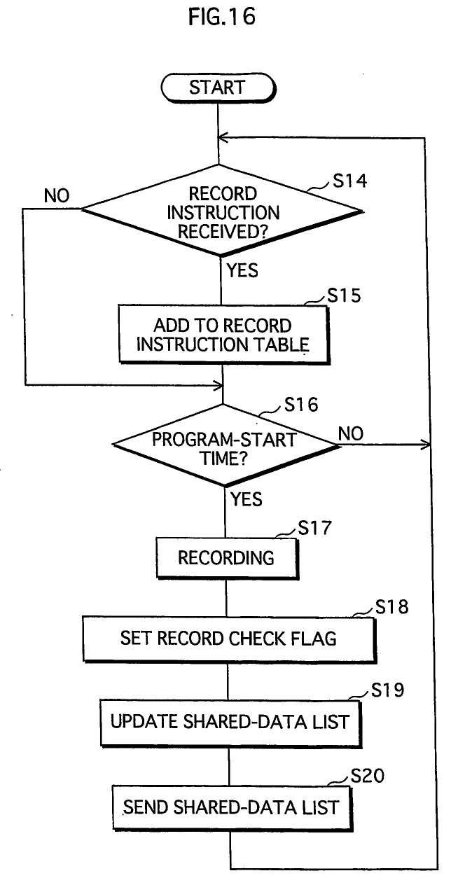

FIG. 16 is a flowchart illustrating operations performed by the recording server 10 for the shared-data list send processing.

On receiving a record instruction from any of the terminals (step S14: YES), the recording server 10 records the program ID contained in the received record instruction and the terminal ID into the recorded data list managed by the recorded-data management unit 15 (step S15). The program ID is also passed to the recording unit 16.

On receiving a broadcast program corresponding to the requested program ID, i.e. when the program-start time of the broadcast program to be recorded is reached (step S16: YES), the recording unit 16 records the received broadcast program into the recorded-data storing unit 19 (step S17). On completion of the recording of the broadcast program, the recording unit 16 sets a recording check flag into the recording checkbox of the recorded data list (step S18), thereby indicating that recording of the broadcast program is completed.

With respect to the recorded data of which recording check flag is set, the shared-data management unit 21 identifies a group to which a corresponding terminal ID belongs, and updates the shred-data list for that group (step S19). The sending unit 20 sends the updated shared-data list to each terminal belonging to the group (step S20).

3.5 Send-Request Reception Processing

Next, description is given to send-request reception processing performed by the terminal 4.

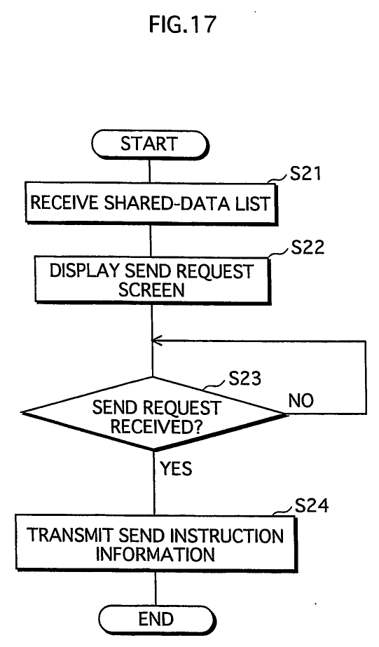

FIG. 17 is a flowchart illustrating operations performed by the terminal 4 for the send-request reception processing.

First, the terminal 4 receives a shared-data list from the recording server 10 (step S21). In response to a user input for initiating a send request entry, the terminal 4 displays on the external monitor a send request screen that is generated based on the received shared-data list (step S22).

On receiving a send request entered by the user into the thus displayed send request screen (step S23: YES), the instruction generating unit 35 generates a send instruction. The communication unit 33 transmits the resulting send instruction to the recording server 10 (step S24).

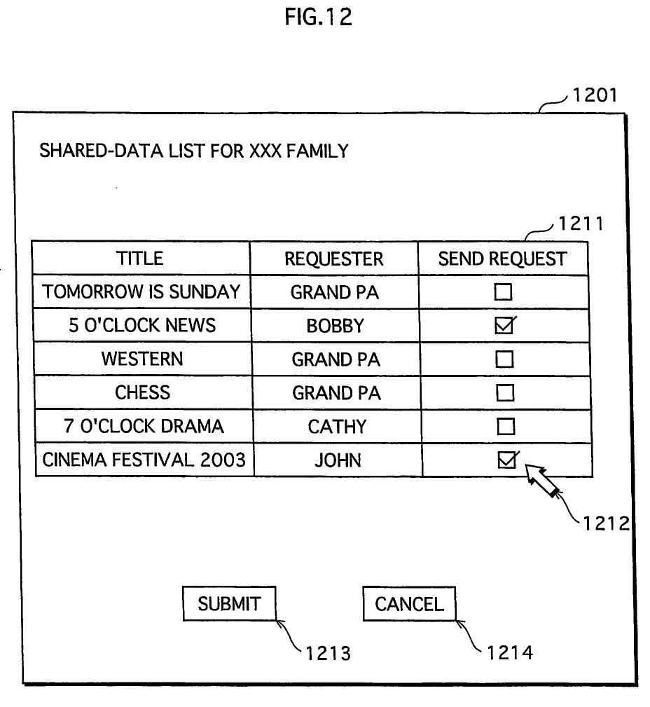

With reference to FIG. 12, specific description is given to the send-request reception processing performed by the terminal 4.

FIG. 12 illustrates one example of a send request screen used for receiving, from a user, a send request requesting a recorded program to be acquired, i.e. to be sent. The send request screen in this example is based on a shared-data list that is distributed from the recording server 10 exclusively to the terminals belonging to the “XXX Family” group.

A send request screen 1201 displays a shared-data list 1211, a pointer 1212, a submit button 1213, a cancel button 1214.

By manipulating a pointing device such as a remote controller, a user moves the pointer 1212 over the shared-data list 1211 displayed, to mark a send request checkbox of a desired broadcast program, whereby a program send request requesting the broadcast program to be sent is set.

The user can submit the set request at a click of the submit button after marking as many checkboxes as the user desires. In response, the instruction generating unit 35 generates send instructions for the broadcast programs corresponding to the marked checkboxes. The communication unit 33 transmits the thus generated send instruction with the terminal ID to the recording server 10.

On the other hand, at a click of the cancel button 1214, the marks of the checkboxes are all cleared.

3.6 Shared-Data Send Processing

Next, description is given to shared-data send processing performed by the recording server 10.

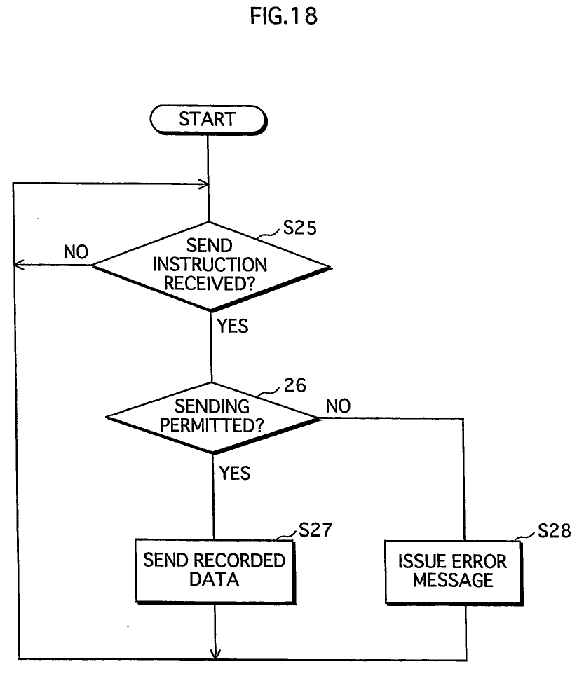

FIG. 18 is a flowchart illustrating operations performed by the recording server 10 for the shared-data send processing.

On receiving a send instruction from any of the terminals (step S25: YES), the recording server 10 refers to a shared-data list generated for a group to which the terminal ID contained in the received instruction belongs. If the program ID contained in the send instruction is found in that shared-data list, the recording server 10 judges that it is permitted to send the broadcast program (step S26: YES). Consequently, the recording server 10 reads from the recorded-data storing unit 19 the recorded data corresponding to the broadcast program to be sent, and transmits the read data to the terminal that issued the send request (step S27). Then, the processing returns to the step S25.

On the other hand, if the program ID contained in the send instruction is not found in the shared-data list for the group to which the terminal ID contained in the send instruction belongs (step S26: NO), the recording server 10 issues an error message to the terminal that issued the send instruction (step S28). Then, the processing returns to the step S25.

4. Modifications

The network recording system according to the present invention may be set so as to notify about a record request that is made by one user, to all the other users in the same group.

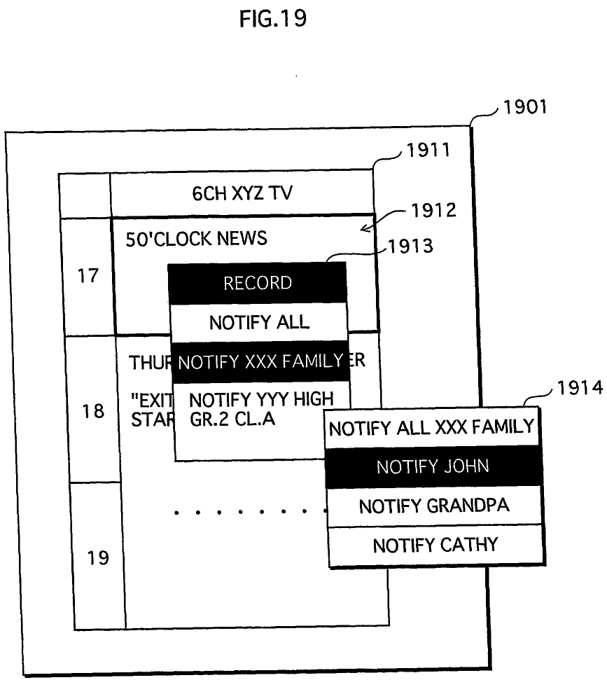

FIG. 19 illustrates one example of a record request screen displayed on an external monitor by a terminal. The record request screen is used for receiving a record request from a user.

A record request screen 1901 is generated by the GUI unit 37, and displayed on the external monitor via the audio/visual output unit 41.

The record request screen 1901 displays a program guide 1911 showing the broadcast schedule of XYZ Television for Osaka Area 6 from 17:00 to 19:00. When a program listing column 1912 is selected with the pointer, a recording detail window 1913 appears.

In the recording detail window 1913 appears a “RECORD” button and buttons used for selecting notification targets. When a user desires to notify one or more users of the group about a record request that the user is now making, the user selects a button corresponding to a desired notification target, thereby making notification setting.

Suppose, for example, the user “BOBBY” who belongs to the “XXX family” and “YYY High Gr. 2 Cl. A” groups illustrated in the figure selects a “NOTIFY ALL” button on the record request screen 1901. With this setting, a notification about a record request made by the user “BOBBY” is sent to all the other users in the two groups.

Further, if individual users in the group are selected from the notification target selecting window 1914, a notification is sent only to the selected users.

Suppose, for example, a “NOTIFY JOHN” button is selected as shown in the figure. With this setting, a notification about a record request made by the user “BOBBY” is sent only to the user “JOHN” who belongs to the “XXX FAMILY” group.

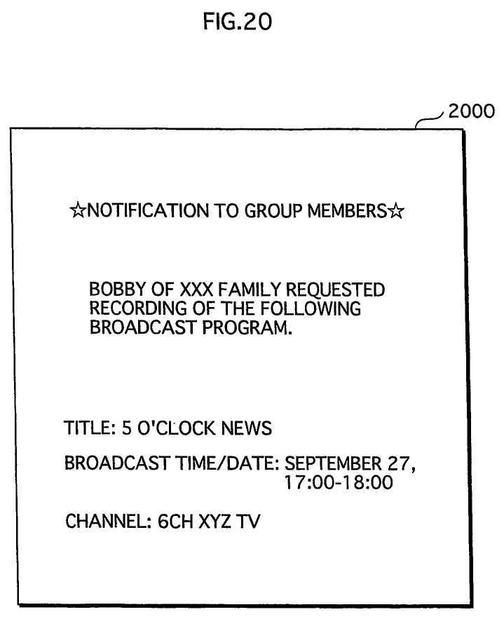

FIG. 20 illustrates a specific example of a record request notification screen 2000 for notifying about a record request. In this example, the user “BOBBY” who belongs to the “XXX FAMILY” group made the record request. At the same time, the user “BOBBY” made the notification setting to issue a notification about the record request to all the other terminals belonging to the same group.

When the record request notification as shown in the figure is displayed on each receiving terminal, the other users become aware of that “5 O'CLOCK NEWS” will be available for the shared use and that it will be possible to download that broadcast program to their own terminals for viewing.

5. Supplemental Note

It is naturally appreciated that the present invention is not limited to the specific embodiment described above, and various modifications such as the following still fall within the scope of the present invention.

(1) The recording server 10 described above may be constituted of a plurality of devices. For example, the recording server 10 may be constituted of a plurality of recording devices and a recording control device controlling the recording devices. Further, the terminals may each have a recording function, so that each terminal may request another terminal to record a broadcast program. Conversely, each terminal may record a broadcast program in response to a record request from another terminal. Still further, it is applicable that the recording control device controls the terminals so as to allow the shared use recorded data.

(2) In the above embodiment, the recording server 10 manages the terminals on a group-by-group basis using their terminal IDs. Yet, the terminals may be managed using their user IDs, user names, or user nicknames. In this case, each terminal may perform user authentication using the user ID, user name, or user nickname, before permitting the user to use a broadcast recording service.

(3) In the above recording server 10, once the recorded-data storing unit 19 is full, it is required to free up some storage space before storing another piece of recorded data.

In order to secure free storage space, the following strategies are generally taken: (i) delete previously recorded data from the oldest piece, (ii) automatically delete recorded data when the data is acquired by a user who requested recording of the data, and (iii) delete recorded data from the recording server in response to a user request.

However, the above strategies lead to the undesirable possibility that recorded data available for the shared use is deleted even if some of the users in the group have not yet acquired the recorded data. This significantly reduces the merit of sharing recorded data.

To address the limitation above, the recording server 10 of the present invention may prohibit deletion of recorded data unless all the users of the group sharing the data acquire the data. In other words, once all the users belonging to the group acquire the recorded data, the recorded data may then be deleted.

To this end, the recording server 10 needs to keep track of whether each piece of recorded data on the shared-data list has been acquired by all the users.

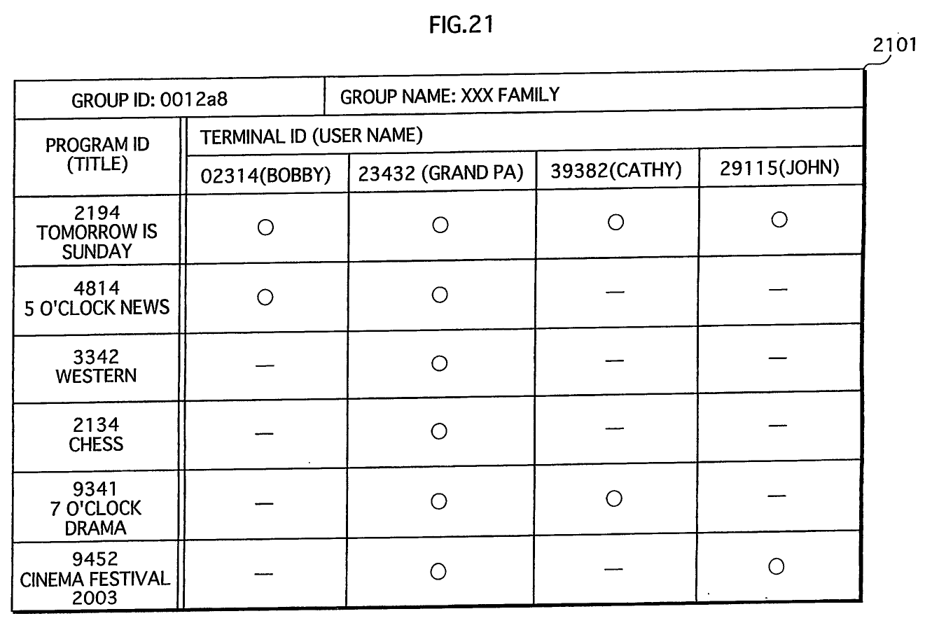

FIG. 21 illustrates one specific example of a shared-data acquisition state table showing whether each piece of shared-data has been acquired by each user of the group.

A shared-data acquisition state table 2101 is managed by the shared-data management unit 21. Each time a user acquires a piece of recorded data, the shared-data management unit 21 updates the table by setting a corresponding flag (represented by ◯ mark in the figure) to indicate that the piece of recorded data has been already acquired.

For example, the figure shows that the piece of recorded data “TOMORROW IS SUNDAY” (program ID: 2194) has been acquired by all the users of the “XXX Family” group. Thus, the shared-data management unit 21 manages the piece of recorded data “TOMORROW IS SUNDAY” as non-protected data that can be deleted. When the recorded-data storing unit 19 becomes full or when a user requests deletion of the recorded data, this piece of recorded data is deleted by the shared-data management unit 21.

The figure further shows that a piece of recorded data “5 O'CLOCK NEWS” (program ID: 4814) has not yet been acquired by the users “CATHY” (terminal ID: 39382) and “JOHN” (terminal ID: 29115) both belonging to the “XXX Family” group. Thus, the shared-data management unit 21 manages the piece of recorded data “5 O'CLOCK NEWS” as protected data of which deletion is prohibited. Consequently, even if the recorded-data storing unit 19 is full or a user requests to delete the piece of recorded data “5 O'CLOCK NEWS”, the shared-data management unit 21 does not delete the data. Here, when receiving such a request to delete protected data, the recording server 10 may issues a notification that deletion of the data is prohibited because the data is not yet acquired by all the users in the group.

Further, when any piece of recorded data has been acquired by all the users in the group, the recording server 10 may issues to each user a notification recommending deletion of that piece of recorded data.

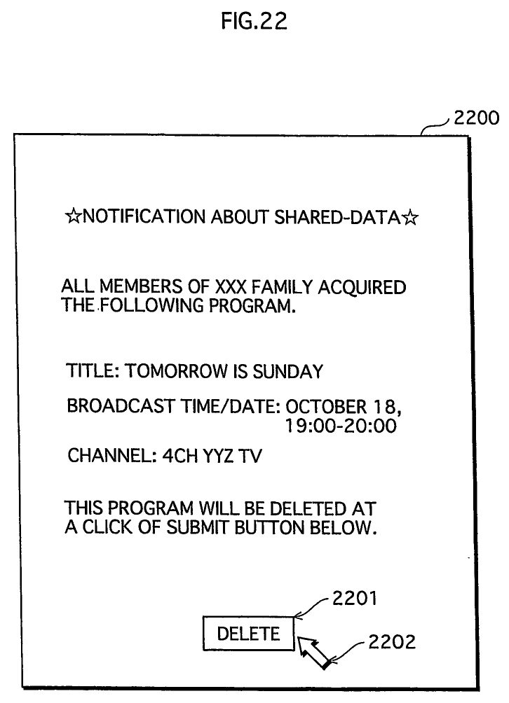

FIG. 22 illustrates one specific example of a notification suggesting that the piece of recorded data “TOMORROW IS SUNDAY” is deleted. The notification is issued by the recording server 10 to each user at the time all the users in the group acquired that piece of recorded data.

As illustrated in the figure, a GUI screen 2200 outputted by a terminal shows that the piece of recorded data “TOMORROW IS SUNDAY” has been acquired by all the users of the “XXX Family” group. At a click of a delete button 2201 with a pointer 2202, the terminal generates a delete instruction to delete the piece of recorded data, and transmits the delete instruction to the recording server 10.

On receiving the delete instruction, the recording server 10 deletes the requested piece of recorded data.

Alternatively, the recording server 10 may automatically delete a piece of recorded data that has been acquired by all the users in the group, and then issues a notification about the delete to each user terminal.

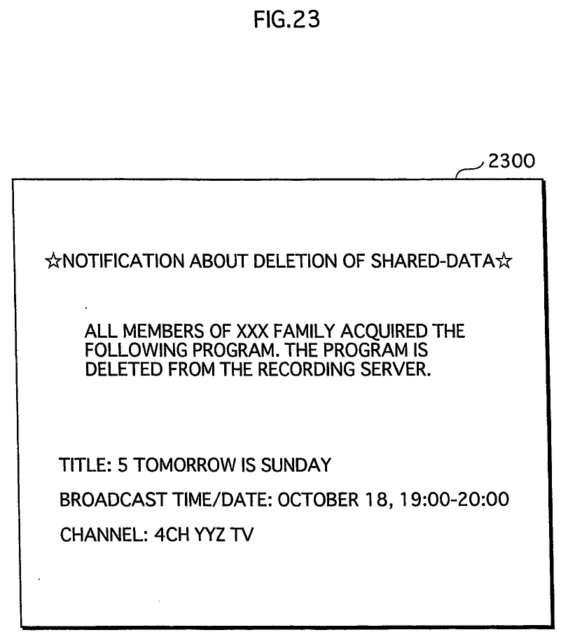

FIG. 23 illustrates a specific example of a notification that the piece of recorded data “TOMORROW IS SUNDAY” has been deleted. The notification is issued by the recording server 10 at the time when all the users in the group acquire that piece of recorded data.

As illustrated in the figure, the GUI screen 2300 outputted by a terminal shows that the piece of recorded data “TOMORROW IS SUNDAY” has been deleted from the recording server 10 because the piece of data was acquired by all the users in the “XXX FAMILY” group.

(4) The present invention may be embodied as a method including the steps for the processing performed by the network recording system 1 described in the above embodiment (in FIGS. 13-18). Further, the present invention may be embodied as a program run by a terminal or a recording server to perform the above steps. Such a program may be distributed in form of a recording medium or via various types of communication paths. Examples of such a recording medium include an IC card, optical disc, flexible disk, and memory.

A distributed program may be installed into a device having a storage function and put to use. By executing the stored program, the device serves as a recording server or a terminal described in the above embodiment.

(5) In the embodiment described above, the ID management unit 13, the recorded-data management unit 15, and the shared-data management unit 21 are implemented on an integrated circuit. Yet, each of the above function blocks may be separately implemented on a single IC chip. Further, in addition to the above function blocks, the registration information obtaining unit 12, the record instruction obtaining unit 14, and the send instruction obtaining unit 22 that are shown in FIG. 1 may be all implemented on a single IC chip.

Note that such an integrated circuit may be referred to as an IC or an LSI circuit depending on the packaging density of the circuit.

Further, as an IC device, a dedicated circuit or general-purpose processor may be used. It is also applicable to use Filed Programmable Gate Array (FPGA) and reconfigurable Processor that allow architectures to be changed. Furthermore, when the advancing technology introduces alternatives to semiconductor ICs, such alternatives may naturally be used. One of such alternatives expected to be introduced is ICs employing biotechnology.

### INDUSTRIAL APPLICABILITY

The present invention is applicable to a network recording system used for providing recording services.

1. A network recording system including a plurality of terminals and a recording server connected via a network,
each terminal comprising:
a transmitting unit operable to transmit to the recording server a record instruction to record a broadcast program and a send instruction to send a recorded broadcast program, each instruction being transmitted together with a requester ID, and
the recording server comprising:
an ID management unit operable to manage specific requester IDs as belonging to a group;
a recording unit operable to record a broadcast program in response to a record instruction transmitted from a terminal;
a recorded-data management unit operable to manage a recorded broadcast program, in association with a requester ID that is transmitted with a record instruction instructed to record the broadcast program; and
a shared-data management unit operable to send, in response to a send instruction, a recorded broadcast program to a terminal that transmitted the send instruction, when (i) a requester ID transmitted with the send instruction is managed by the ID management unit as belonging to a group and (ii) the recorded broadcast program to be sent is associated by the recorded-data management unit with a requester ID belonging to the group.

2. The network recording system according to claim 1, wherein
the shared-data management unit generates, on a group-by-group basis, a shared-data list showing recorded broadcast programs that are associated with requester IDs belonging to a respective group out of all recorded broadcast programs managed by the recorded-data management unit, and transmits the shared-data list to each terminal, and
each terminal further comprises a generating unit operable to generate a send instruction based on the shared-data list.

3. The network recording system according to claim 2, wherein each terminal further comprises:
a presentation unit operable to present the shared-data list to a user; and
a receiving unit operable to receive, from the user, a specification of a recorded broadcast programs selected from the shared-data list, and
the generating unit generates a send instruction to send the recorded broadcast program that is selected by the user.

4. The network recording system according to claim 3, wherein
the receiving unit receives designation of a group from a user,
the transmitting unit transmits, together with a requester ID, group information showing the designated group to the recording server, and
the ID management unit manages group information transmitted from a terminal, in association with a requester ID that is transmitted with the group information.

5. The network recording system according to claim 3, wherein
the receiving unit receives, from a user, a record request requesting to record a broadcast program, and also receives notification setting as to whether to issue a notification about the record request to other users belonging to a same group to which the user belongs,
the generating unit generates a record instruction based on the received record request,
the transmitting unit transmits, in addition to the generated record instruction, the notification setting together with a requester ID to the recording server, and
the shared-data management unit issues, in accordance with notification setting transmitted with a record instruction from a terminal, a notification about the record instruction to each terminal that transmitted a requester ID belonging to a same group to which the requester ID transmitted with the notification setting belongs.

6. The network recording system according to claim 3, wherein
the receiving unit receives, from a user, a delete request requesting to delete a recorded broadcast program,
the generating unit generates a delete instruction based on the received delete request,
the transmitting unit transmits the generated delete instruction together with a requester ID to the recording server, and
the shared-data management unit deletes, in response to a delete instruction transmitted from a terminal, a recorded broadcast program from the recording server, when the recorded broadcast program to be deleted is associated with a requester ID belonging to a same group to which a requester ID transmitted with the delete instruction belongs.

7. The network recording system according to claim 2, wherein
the shared-data management unit deletes from the recording server a recorded broadcast program that is listed in the shared-data list, when the recorded broadcast program is sent to all users or terminals identified by the requester IDs belonging to the group.

8. The network recording system according to claim 2, wherein
each time the recorded-data management unit newly associates a requester ID and a recorded broadcast program, the shared-data management unit updates the shared-data list and transmits a new shared-data list to each terminal.

9. A recording server comprising:
a receiving unit operable to receive, from an external device, a record instruction to record a broadcast program and a send instruction to send a recorded broadcast program, each instruction being attached with a requester ID;
an ID management unit operable to manage specific requester IDs as belonging to a group;
a recording unit operable to record a broadcast program in response to a record instruction received by the receiving unit;
a recorded-data management unit operable to manage a recorded broadcast program, in association with a requester ID that is received with a record instruction instructed to record the broadcast program; and
a shared-data management unit operable to send, in response to a send instruction, a recorded broadcast program to an external device from which the send instruction is received, when (i) a requester ID received with the send instruction is managed by the ID management unit as belonging to a group and (ii) the recorded broadcast program to be sent is associated by the recorded-data management unit with a requester ID belonging to the group.

10. A recorded data sending method for use by a recording server having: a receiving unit operable to receive a record instruction to record a broadcast program and a send instruction to send a recorded broadcast program each transmitted from an external source together with a requester ID; and a recording unit operable to record a broadcast program in response to a received record instruction, the recorded data sending method comprising steps of:
managing specific requester IDs as belonging to a group;
managing a broadcast program that is recorded in response to a record instruction received by the receiving unit, in association with a requester ID received with the record instruction; and
sending, in response to a send instruction received from an eternal device, a recorded broadcast program to the external device from which the send instruction is received, when (i) a requester ID received with the send instruction is managed in the requester ID managing step as belonging to a group and (ii) the recorded broadcast program to be sent is associated in the broadcast program managing step with a requester ID belonging to the group.

11. A program for use by a computer that performs a recorded data sending process, the computer acting as a recording server having: a receiving unit operable to receive a record instruction to record a broadcast program and a send instruction to send a recorded broadcast program each transmitted from an external source together with a requester ID; and a recording unit operable to record a broadcast program in response to a received record instruction, the recorded data sending process comprising steps of:
managing specific requester IDs as belonging to a group;
managing a broadcast program recorded in response to a record instruction received by the receiving unit, in association with a requester ID received with the record instruction; and
sending, in response to a send instruction received from an eternal device, a recorded broadcast program to the external device from which the send instruction is received, when (i) a requester ID received with the send instruction is managed in the requester ID managing step as belonging to a group and (ii) the recorded broadcast program to be sent is associated in the broadcast program managing step with a requester ID belonging to the group.

12. A recording medium storing a program for use by a computer that performs a recorded data sending process, the computer acting as a recording server having: a receiving unit operable to receive a record instruction to record a broadcast program and a send instruction to send a recorded broadcast program each transmitted from an external source together with a requester ID; and a recording unit operable to record a broadcast program in response to a received record instruction, the recorded data sending process comprising steps of:
managing specific requester IDs as belonging to a group;
managing a broadcast program recorded in response to a record instruction received by the receiving unit, in association with a requester ID received with the record instruction; and
sending, in response to a send instruction received from an eternal device, a recorded broadcast program to the external device from which the send instruction is received, when (i) a requester ID received with the send instruction is managed in the requester ID managing step as belonging to a group and (ii) the recorded broadcast program to be sent is associated in the broadcast program managing step with a requester ID belonging to the group.

13. An integrated circuit for use in a recording server that has: a receiving unit operable to receive a record instruction to record a broadcast program and a send instruction to send a recorded broadcast program each transmitted from an external source together with a requester ID; and a recording unit operable to record a broadcast program in response to a received record instruction, the integrated circuit comprising:
an ID management module operable to manage specific requester IDs as belonging to a group;
a recorded-data management module operable to manage a recorded broadcast program that is recorded in response to a record instruction received by the receiving unit, the recorded broadcast being managed in association with a requester ID that is received with the record instruction; and
a shared-data management module operable to send, in response to a send instruction, a recorded broadcast program to a terminal from which the send instruction is received, when (i) a requester ID received with the send instruction is managed by the ID management module as belonging to a group and (ii) the recorded broadcast program to be sent is associated by the recorded-data management module with a requester ID belonging to the group.
